(19) United States
(12) Patent Application Publication
(10) Pub. No.: US 2012/0304068 A1
(43) Pub. Date: Nov. 29, 2012

(54) PRESENTATION FORMAT FOR AN APPLICATION TILE

(76) Inventors: Nazia Zaman, Kirkland, WA (US); Ethan Nelson Ray, Redmond, WA (US); Sean L. Flynn, North Bend, WA (US); Anthony L. Willie, Woodinville, WA (US)

(21) Appl. No.: 13/118,288

(22) Filed: May 27, 2011

(51) Int. Cl. G06F 3/01

(52) U.S. Cl. 715/730

(57) ABSTRACT

This document describes techniques enabling a presentation format for an application tile. These techniques permit a user to view changes to an application through a tile of a user interface, the tile having one of various presentation formats through which a user may view content associated with those changes.

### BACKGROUND

Conventional operating systems permit users to launch applications, often through a user interface having selectable icons for the applications. In some cases a user selects to launch an application from this user interface and does not care whether there is anything new for that application.

In many cases, however, users launch applications to find out what is new in those applications. A user wishing to find out what is new in her applications, for example, typically selects an icon for a desired application, in response to which the conventional operating system launches the application. This application then opens and, assuming it is one that presents content, presents that content. For some applications, such as news or social-networking websites, the application retrieves content from a remote source and then presents that content. It is at this point that the user sees the content, which may or may not be new since the last time the user viewed content for that application.

The user may continue this process of selecting applications, in response to which they are launched and present content, and then viewing the presented content to find out what, if anything, is new. Following this process will permit a user to see what is new in her applications, but doing so takes significant amounts of time and effort. This process also expends computing and bandwidth resources. Worse still, in some cases her applications may not have any new content, in which case all of this time, effort, and resources are wasted.

### SUMMARY

This document describes techniques enabling a presentation format for an application tile. These techniques permit a user to view changes to an application through a tile of a user interface, the tile having one of various presentation formats through which a user may view content associated with those changes.

This summary is provided to introduce simplified concepts enabling a presentation format for an application tile that is further described below in the Detailed Description. This summary is not intended to identify essential features of the claimed subject matter, nor is it intended for use in determining the scope of the claimed subject matter. Techniques and/or apparatuses enabling a presentation format for an application tile are also referred to herein separately or in conjunction as the “techniques” as permitted by the context.

### BRIEF DESCRIPTION OF THE DRAWINGS

Embodiments enabling a presentation format for an application tile are described with reference to the following drawings. The same numbers are used throughout the drawings to reference like features and components:

FIG. 1 illustrates an example system in which techniques enabling a presentation format for an application tile can be implemented.

FIG. 2 illustrates an example embodiment of the computing device of FIG. 1.

FIG. 3 illustrates an example embodiment of the remote provider of FIG. 1.

FIG. 4 illustrates an example embodiment of the report compiler of FIG. 1.

FIG. 5 illustrates an example method for presenting a user interface having selectable tiles at least one of which presents a change to an application.

FIG. 6 illustrates an example user interface having fourteen selectable tiles.

FIG. 7 illustrates an example presentation of a selected application in an immersive environment.

FIG. 8 illustrates a selectable tile of FIG. 6 along with selectable sections reporting changes.

FIG. 9 illustrates an example presentation of a selected application in a windows-based environment.

FIG. 10 illustrates a pop-up window having content associated with a change to an application.

FIG. 11 illustrates an example method enabling presentation of, and browsing through, content changes of an application through a tile of a user interface.

FIG. 12 illustrates an example selection to browse content through a tile.

FIG. 13 illustrates an update to content of the tile of FIG. 12 presented responsive to the selection to browse content.

FIG. 14 illustrates an example method enabling presentation of multiple content changes associated with an application through a tile of a user interface.

FIG. 15 illustrates presentation of additional content through a tile.

FIG. 16 illustrates an example tile having various indicators.

FIG. 17 illustrates an example method enabling presentation of a content change associated with an application according to a presentation format.

FIG. 18 illustrates an example method enabling presentation of a content change associated with an application according to a presentation format in the context of extensible markup language (XML).

FIG. 19 illustrates two tiles having content changes presented according to two presentation formats.

FIG. 20 illustrates a tile at two different times presenting content from a single report and based on one presentation format.

FIG. 21 illustrates an example device in which techniques for presenting an application change through a tile can be implemented.

### DETAILED DESCRIPTION

### Overview

This document describes techniques and apparatuses enabling presentation of content changes through an application tile according to various presentation formats. These techniques enable a user to see content associated with content changes to an application or other information about the application, such as a new article, new email, or a software update having become available since a user last visited the application. By so doing, the techniques enable a user to forgo visiting the application or permit the user to quickly and easily decide whether or not to visit the application. Furthermore, the techniques permit application developers to select from various presentation formats that permit ease of development for application developers, reduce bandwidth usage, and/or reduce server-side resource costs. In some embodiments, these presentation formats, though varied, manage information density, permit a harmonious look and feel, and/or permit easy scan-ability by users when multiple tiles are presented within a single user interface.

Assume, for example, that a user wishes to see whether or not there is anything new for an application, such as a social networking application. The techniques enable the user to view changes associated with the social networking application without visiting the application. The techniques may do so through a tile that presents changes since the user last viewed the application, such as content associated with a friend tagging the user in a photo. This presented content can include an image of the user's friend, the photo in which the user is tagged, or a portion of the friend's message, all of which are presented according to a presentation format appropriate to the images and message. On viewing this content, the user sees some or all of the content associated with the change, thereby permitting the user to avoid visiting the application or prompting the user to visit the application for additional content. Thus, in many cases the user decides to visit the application based on the content presented in the tile.

This is but one example of the many ways in which the techniques enable users to view changes to an application through a tile according to one of various presentation formats. Numerous other examples, as well as ways in which the techniques operate, are described below.

This discussion proceeds to describe an example environment in which the techniques may operate, methods performable by the techniques, and an example apparatus below.

### Example Environment

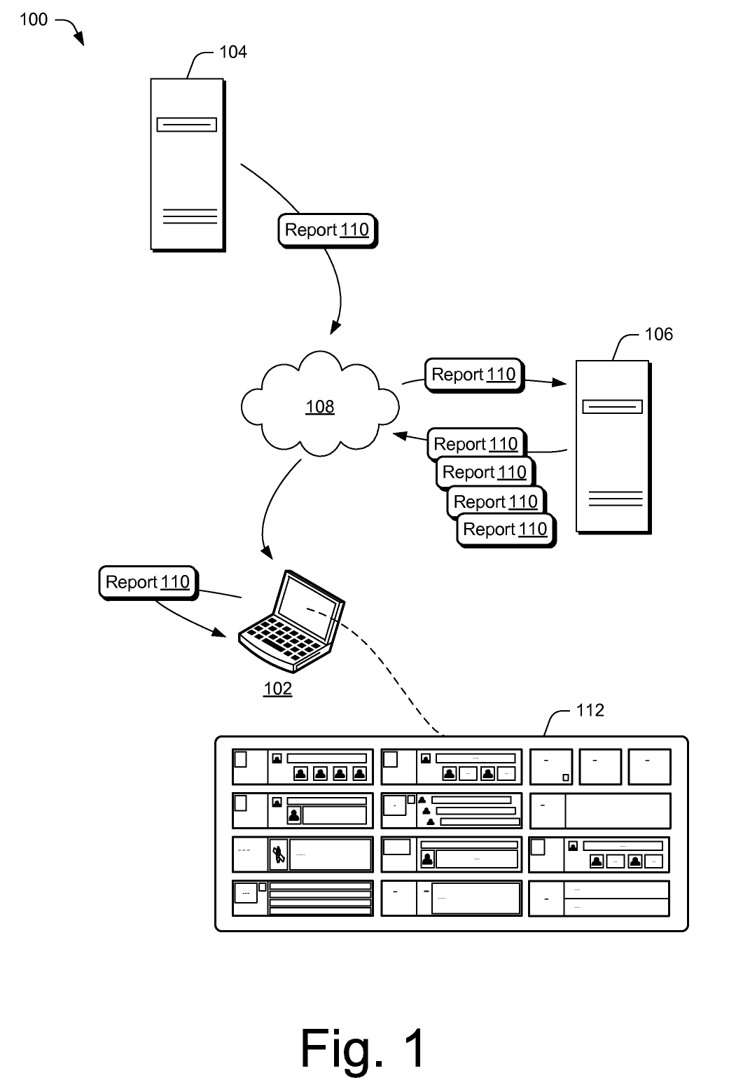

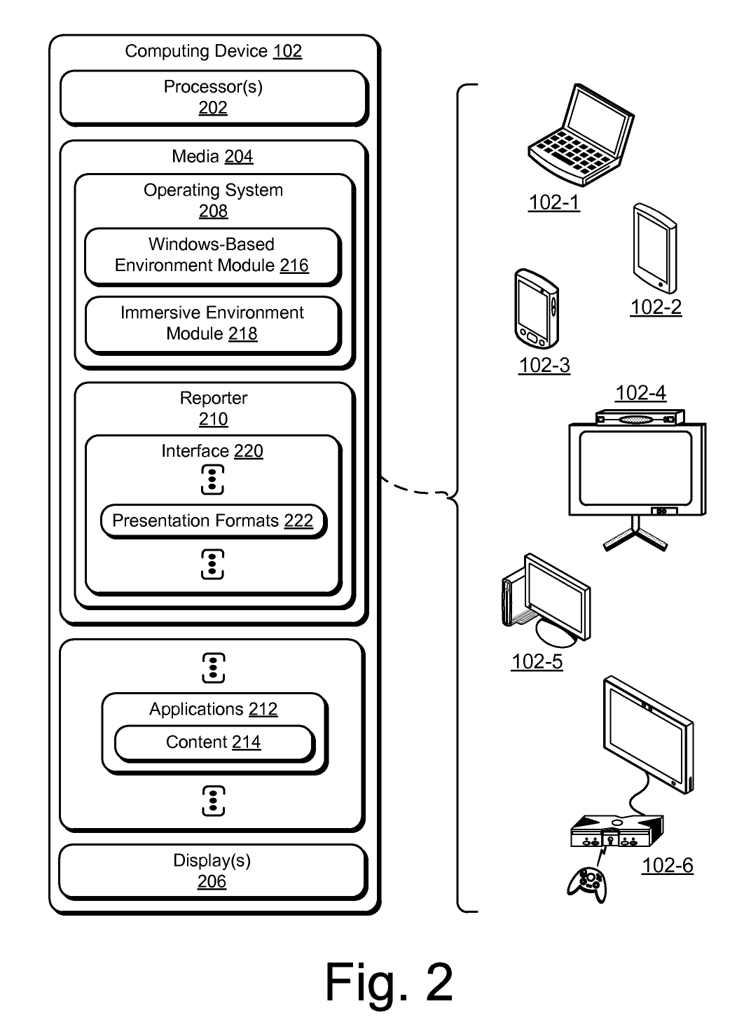

FIG. 1 illustrates an example environment 100 in which techniques enabling a presentation format for an application tile can be embodied, as well as other operations. Environment 100 includes a computing device 102, remote provider 104, optional report compiler 106, and communication network 108, which enables communication between these entities. In this illustration, computing device 102 receives reports 110 from three sources, remote provider 104, report compiler 106, and an application executing on computing device 102 (this application is shown in FIG. 2).

Each report 110 indicates a change to its associated application and an indication of format in which to present this change. This change to an application can be to the application's content or status, such as a new email, entry, or article, or that a software update or expiration is approaching, to name just a few. Computing device 102 presents user interface 112, which includes tiles for applications, many of which present these changes.

FIG. 2 illustrates an example embodiment of computing device 102 of FIG. 1, which is illustrated with six examples devices: a laptop computer 102-1, a tablet computer 102-2, a smart phone 102-3, a set-top box 102-4, a desktop computer 102-5, and a gaming device 102-6, though other computing devices and systems, such as servers and netbooks, may also be used.

Computing device 102 includes or has access to computer processor(s) 202, computer-readable storage media 204 (media 204), and one or more displays 206, four examples of which are illustrated in FIG. 2. Media 204 includes an operating system 208, reporter 210, and applications 212, each of which may provide content 214.

Operating system 208 includes or has access to window-based environment module 216 and/or immersive environment module 218. Applications selected through the techniques can be presented through a windows-based or immersive environment, as well as others.

Windows-based environment module 216 presents applications and accompanying content through windows having frames. These frames provide controls through which to interact with an application as well as controls enabling a user to move and size the window.

Immersive environment module 218 provides an environment by which a user may view and interact with one or more of applications 212 and corresponding content 214. In some embodiments, this environment presents content of, and enables interaction with, applications with little or no window frame and/or without a need for a user to manually size or position content. This environment can be, but is not required to be, hosted and/or surfaced without use of a typical desktop environment. Thus, in some cases immersive environment module 218 presents an immersive environment that is not a window (even one without a substantial frame) and precludes usage of desktop-like display elements (e.g., a taskbar). Further still, in some embodiments this immersive environment is similar to an operating system in that it is not closeable or capable of being un-installed. Examples of immersive environments are provided below as part of describing the techniques, though they are not exhaustive or intended to limit the techniques.

Reporter 210 includes, has access to, or generates an application-selectable user interface 220 (interface 220), an example of which is shown at 112 in FIG. 1. Interface 220 includes or has access to presentation formats 222, at least one of which is indicated within an applicable report 110. Reporter 210 reports changes associated with one or more of applications 212 through interface 220. As noted above, reports 110 may be received directly from one or more of applications 212, or another entity associated with one or more of applications 212, such as remote provider 104 or report compiler 106.

As noted, each report 110 indicates which presentation format 222 is intended. In response, reporter 210 reports changes in the appropriate format through interface 220. Reports 110 can include a presentation format indicator, text, and images or image locators (e.g., Universal Resource Locators—URLs), and can be arranged as or include a flat list, spreadsheet, or eXtensible Markup Language (XML) document, to name just three examples. Additionally, in some instances reports 110 may also include dynamic content such as hyperlinks, richer forms of content including audio and/or video, or elements that accept user input for content interaction. Presentation formats 222 indicate locations and sizes for images, text, and/or dynamic content within application tiles. Presentation formats 222 can be eXtensible Stylesheet Language Transformations (XSLT) in cases where reports 110 are received in or include an XML document. In such a case, reporting in interface 220 is presented using Hyper-Text Markup Language (HTML), though use of XSLT, XML, and HTML are optional.

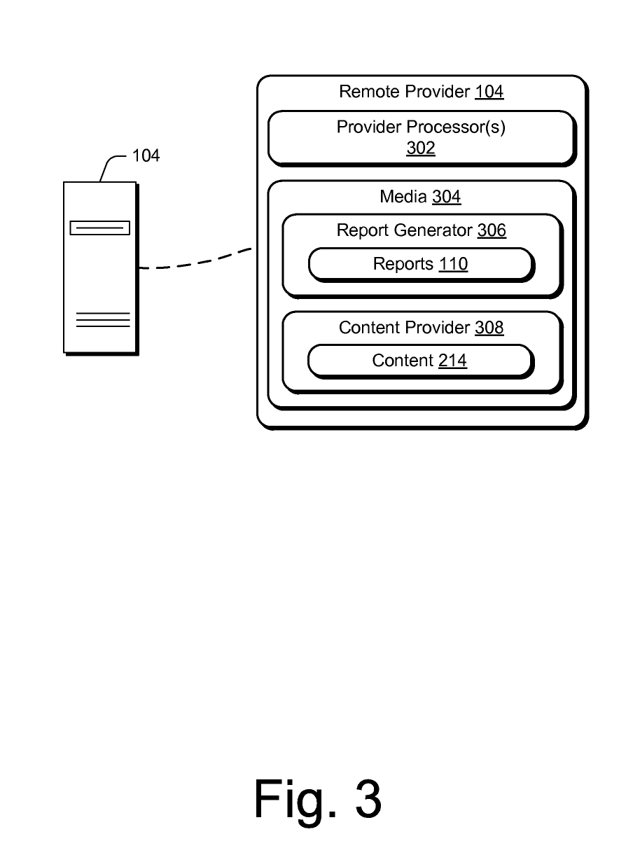

FIG. 3 illustrates example embodiments of remote provider 104. Remote provider 104 is shown as a singular entity for visual brevity, though multiple remote providers 104 are also contemplated herein. Remote provider 104 includes or has to access to provider processor(s) 302 and provider computer-readable storage media 304 (media 304). Media 304 includes report generator 306 and content provider 308.

Report generator 306 is capable of providing one or more reports 110 to computing device 102, either directly or indirectly through report compiler 106. In some embodiments, reports 110 include information useful for indicating a change to an application, presenting content associated with the change, or visiting the application (e.g., with URLs).

Report generator 306 may act responsive to reporter 210, such as a request from reporter 210 for reports 110, though report generator 306 may also act to periodically send, or consistently make available, new and/or interesting content or data as it become available. Report generator 306 may indicate what is new since a user last selected a particular application, though it may also simply provide reports 110, with which reporter 210 may instead determine what is or is not new.

Content provider 308 provides content, such as content 214 associated with application 212. Content provider 308 may act in conjunction with report generator 306, such as to provide content 214 to report generator 306, which report generator 306 then provides a portion of (or sometimes all of) in report 110.

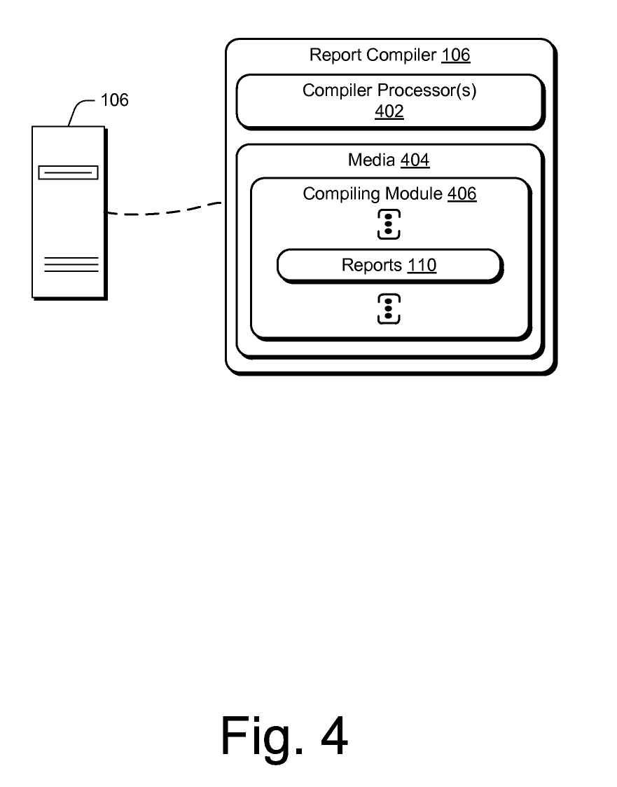

FIG. 4 illustrates an example embodiment of report compiler 106. Report compiler 106 is shown as a singular entity for visual brevity, though multiple report compilers 106 may also be used. Report compiler 106 includes or has to access to compiler processor(s) 402 and compiler computer-readable storage media 404 (media 404). Media 404 includes compiling module 406, which is capable of receiving and compiling reports 110 from one or more sources, such as report provider 104. Compiling module 406 may receive reports for later provision to computing device 102, such as periodically or when computing device 102 indicates that it is on, online, active, idle, or in a particular state. Compiling module 406 may determine which changes are new since a particular user last viewed content from an application and provide those of the reports 110 indicating these changes.

Ways in which entities of FIGS. 1-4 act and interact are set forth in greater detail below. The entities illustrated for computing device 102, remote provider 104, or report compiler 106, respectively, can be separate or integrated.

### Example Methods

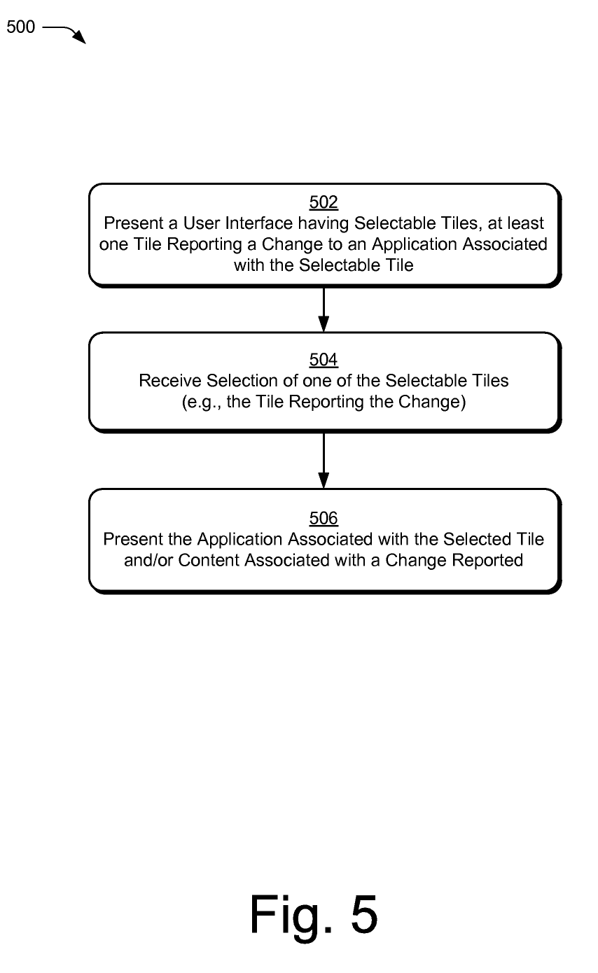

FIG. 5 depicts a method 500 for presenting a user interface having selectable tiles at least one of which presents a change to an application. In portions of the following discussion reference may be made to environment 100 of FIG. 1 and as detailed in FIGS. 2-4, reference to which is made for example only.

Block 502 presents a user interface having multiple, selectable tiles associated with multiple applications, respectively. The tiles can present text and/or images or rich content such as audio, video, and/or user control elements. Contents of a tile can be presented as a label for an associated application within in a user interface or menu in which the tile is presented. In some cases, tiles present specific content associated with an application when implemented as a label for that application. At least one of the multiple selectable tiles reports a change associated with the application to which the selectable tile is associated, though multiple changes for multiple applications or the same application may also be reported.

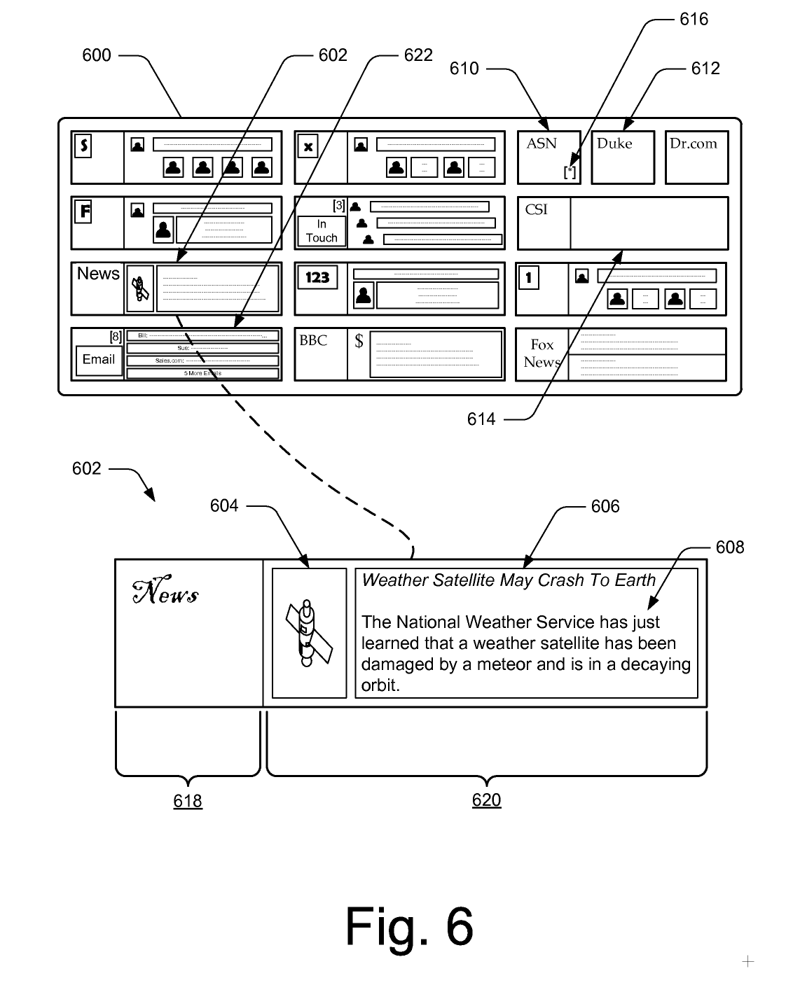

By way of example, consider a case where reporter 210 of FIG. 2 presents a user interface 600 shown in FIG. 6. This user interface 600 is but one of many types of user interfaces contemplated by user interface 220 of FIG. 2, including a user interface having a single tile. User interface 600 includes fourteen selectable tiles, eleven of them relatively large and three relatively small.

This example user interface 600 reports changes to ten of the eleven larger tiles and one of the three small tiles, though any variation of such a presentation is contemplated, such as changes to all or none of the selectable tiles. Note that these changes, even if all of these changes were already received at the time a user selects to view user interface 600, may be presented to each of the various tiles and portions of the tiles progressively. This progressive alteration of the tiles can make user interface 600 look animated. Thus, the changes to the tiles are not necessarily made all at once.

Further, in cases where multiple changes for an application are known, reporter 210 may present the newest of the changes or rotate through these changes. Reporter 210 may rotate through changes to maintain a “live” feel to user interface 600 or responsive to activity or inactivity with a tile. Inactivity with a tile may indicate that the currently-indicated change is not of interest to a user. As another of the changes may be of more interest, the most-recent change may be rotated off of a tile and an older (but still new) change rotated on to the tile.

Consider first selectable tile 602, which is shown expanded in FIG. 6. This selectable tile 602 is associated with one of applications 212 of FIG. 2, namely a “News” application. As shown, selectable tile 602 reports a change associated with this application 212 within selectable tile 602, the change relative to a prior viewing, selection, or launching of this application 212 by a user associated with computing device 102.

Assume that a user viewed the News application at 9 am and, on viewing user interface 600, is presented with selectable tile 602 reporting a change to the News application since 9 am (at 3 pm the same day, for example). Here the change is a new article concerning a weather satellite that has been damaged by a meteor and may crash to earth. Portions of content associated with the change (the change being the new article) are shown in selectable tile 602. These portions each report the change by indicating that a new article is now available, here with an image 604 of a satellite, a title of the article at 606, and a first sentence of the article at 608.

Consider also three other example selectable tiles, small selectable tiles 610 and 612, and another of the large selectable tiles 614. Small selectable tile 610 reports a change to an application associated with this tile, namely the “ASN” application. Tile 610 reports a change with a change indicator 616 marked as “*”, though this indicator 616 does not indicate how many changes or any content associated with that change. This abbreviated report on a change may be desirable when the application associated with the tile is not generally important to the user, or changes are often of a similar type and thus presenting content of the change is not meaningful, or simply because the user desires it.

Small selectable tile 612, on the other hand, does not report any changes. This non-reporting provides the user with valuable information, namely that the user need not select tile 612 to see something new for the “Duke” application, as no changes exist since the user last visited the application.

Large selectable tile 614 also does not report any changes, thus also providing the user with valuable information concerning changes (or lack thereof) for the “CSI” application.

As described, reporter 210 enables selection of applications and reports changes to those applications. Reporter 210 may also enable different selections through different areas of a tile. Consider again tile 602. Here reporter 210 enables selection through application-identifying area 618 and content presentation area 620. This application-identifying area 618 shows an application-selected identifier for the “News” application, namely “News” in a particular font and color (color not shown). Reporter 210 enables a selection made to this application-identifying area 618 to present the “News” application at a default or prior-viewed setting, such as a home page or a last-viewed page of content. Thus, on selection of application-identifying area 618, reporter 210 may refrain from presenting content associated with the reported change.

Reporter 210 enables a selection made to content presentation area 620 to present the “News” application with the change, such as presenting content associated with the change, here opening a webpage at a universal resource locator (URL) associated with the content change. In such a case, reporter 210 presents the News application having the article that was shown in part in content presentation area 620.

Some tiles may indicate multiple changes, such as reporting (with some associated content) the two newest entries to a social-networking website or emails received since the user last viewed an email application. In such a case, reporter 210 enables selection to each section reporting the change to present the associated application with content associated with that change, such as to open one of multiple emails reported.

By way of review, reporter 210 can report changes to various applications responsive to received reports, such as reports 110 of FIG. 1, which can be received one-at-a-time, after compiling into batches, and/or from various sources. These reports 110 can be received or retrieved periodically, on selecting to display user interface 220, and/or in real time. User interface 600, for example, may alter selectable tiles as a user views it due to reports coming in and being reported. Thus, reporter 210 may act to actively update reporting for applications in a user interface through which a user can select applications.

Reporter 210 may determine which reports 110 indicate changes to an application since the user last viewed or interacted with the application, though in some other cases an entity providing the report instead determines this (e.g., remote provider 104, report compiler 106, or application 212).

Further, reporter 210 receives reports along with an indication of a presentation format in which the reports are preferred to be presented. This presentation format preference may be selected by an entity associated with the respective application, such as a social-networking server associated with a social-networking application. Various examples of presentation formats 222 are illustrated in FIG. 6. Large selectable tile 602, for example, presents only a most-recent change along with three portions of content for that change. Small selectable tile 610, conversely, presents only a change indicator 616 with no content. Presentation formats 222 and ways in which they can be used are set forth in greater detail elsewhere herein.

Returning to method 500, block 504 receives selection of one of the multiple, selectable tiles, such as a tile reporting a change. The selection received can be to various areas (or sections of areas) of a selectable tile, responsive to which reporter 210 presents the application associated with the selectable tile, though how presented may vary based on which area is selected. As noted, the application associated with a selectable tile may or may not be executing. Consider, for example, large selectable tile 602 and another large selectable tile 622. Tile 602 is associated with a “News” application of applications 212 of FIG. 2. Tile 622 is associated with an email application of applications 212. For this example, assume that the News application is not executing and that reports are received from a remote entity associated with the News application, such as remote provider 104. Assume also that the email application is local to computing device 102 and is executing. Reports 110 for the email application are received by reporter 210 direct from the email application.

Continuing the ongoing embodiment, assume that reporter 210 receives a selection to application-identifying area 618, such as through a mouse selector or a gesture via a touch-screen displaying user interface 600, such as one of displays 206 shown in FIG. 2.

Block 506 presents the application associated with the selected tile and/or content associated with a change reported in the selected tile. When block 506 presents the application, it does so in a manner in which the application may be interacted with, e.g., in an immersive or windows-based environment. This presentation may also or instead present content associated with a reported change but not necessarily the application itself as described in further detail below.

This presentation may include launching the application and then presenting it, such as in a window via windows-based environment module 216 or in an immersive environment via immersive environment module 218, both of FIG. 2. If the application is already executing, a launch is not needed. Responsive to receiving a selection of a selected tile, the techniques may provide a visual indication of the selection, such as to animate the selected portion of the tile. By so doing, the techniques reinforce the type of selection. Furthermore, the techniques may present, in response to the selection, an interface or menu or selectable control associated with the application and through which a user may interact, such as to select to launch the application in a particular manner or environment, at a particular content, and the like.

Concluding the ongoing embodiment, reporter 210 presents the News application in response to selection of selectable tile 602, here to application-identifying area 618. This presentation includes launching the News application, as it was not executing at selection. As noted, reporter 210 may present and/or launch an application through an instruction to another entity, such as the above-mentioned modules 216 or 218.

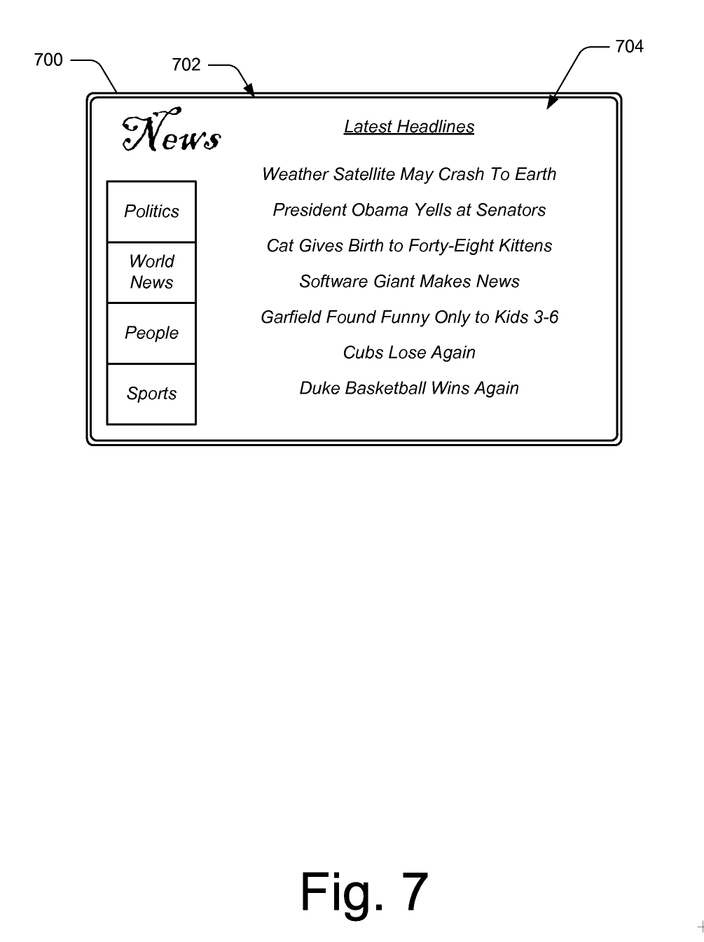

FIG. 7 illustrates an example presentation of the News application in an immersive environment 700. Because application-identifying area 618 was selected, a default presentation (here a home page) for the News application is shown. This home page is shown at 702 and includes various headlines 704 for selection, one of which is the most-recent article also shown at 606 in FIG. 6. While this title is shown, the home page is presented rather than a webpage having a full representation of the content or otherwise devoted to the article, which would otherwise be presented had the selection been made to content presentation area 620.

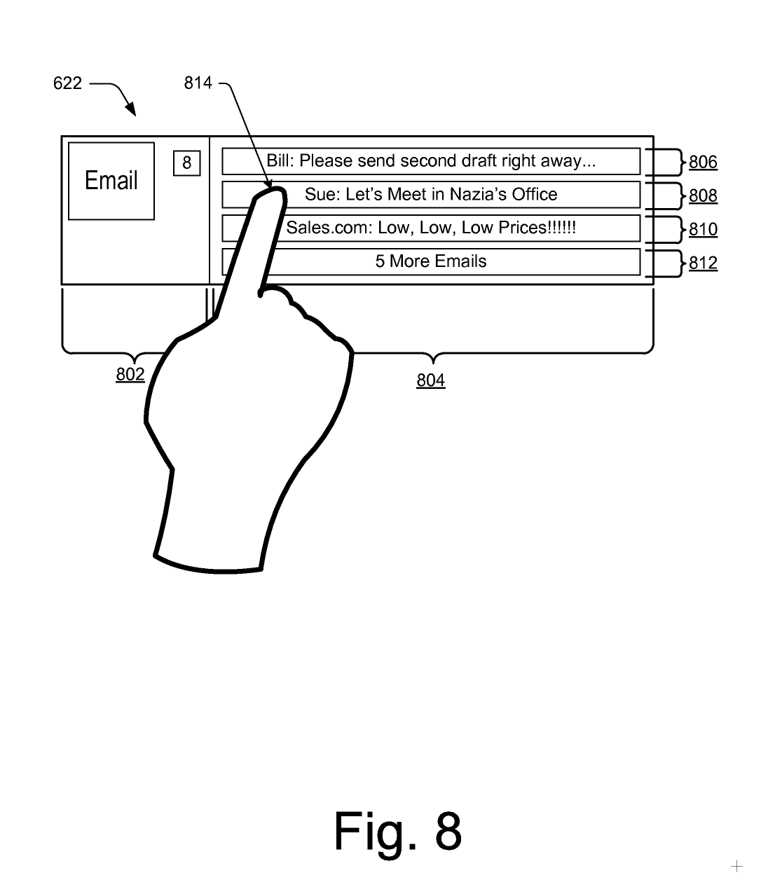

By way of another example, consider a case where selection is received at block 504 through large selectable tile 622 of FIG. 6, which is expanded for clarity in FIG. 8. Tile 622 is shown having an application-identifying area 802 and a content presentation area 804. Content presentation area 804 includes four selectable sections reporting changes, sections 806, 808, 810, and 812. Each of selectable sections 806, 808, and 810 reports content associated with a change, here each a sender and a subject line of an email. Section 812 reports five changes, here that five other emails have also been received since the email application was last viewed by the user. In this example, selection is received to section 808 through a gesture 814 made to a touch screen.

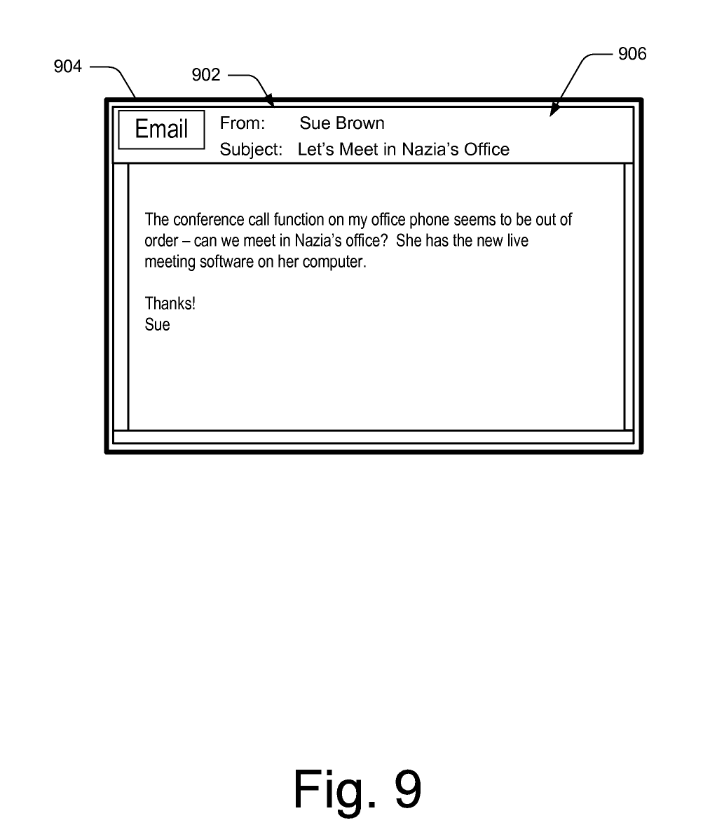

Reporter 210, at block 506, presents the selected email application and content of the email associated with the selection. Here the application is currently executing, therefore reporter 210 does not launch the email application. Presentation of the email application and the change reported, rather than a home or default presentation, is shown in FIG. 9 at 902 in a window 904. Note that reporter 210 may cause this presentation in a window superimposed over the application-selectable user interface or hide the user interface and present the window in a different environment. Here reporter 210 hides the user interface and presents the email application at 902 showing content associated with the selection received at 906.

In still another example, consider again FIG. 8. In some cases selection made to a selectable tile indicating a change may present content associated with that change. This presentation may be commensurate with presentation of the application as described above. In some other cases, the content is shown without hiding the user interface and/or without presenting the application in a conventional manner. Assume, for the selection 814 of FIG. 8, that reporter 210, rather than presenting the email application and the content, instead presents content associated with the change on its own. In this case, more or all of the content associated with that change is shown. Assume, for example, that most or all of the content associated with a new email from Sue was received in one of the reports 110. Reporter 210 may present the rest of this content, such as within or superimposed over user interface 600.

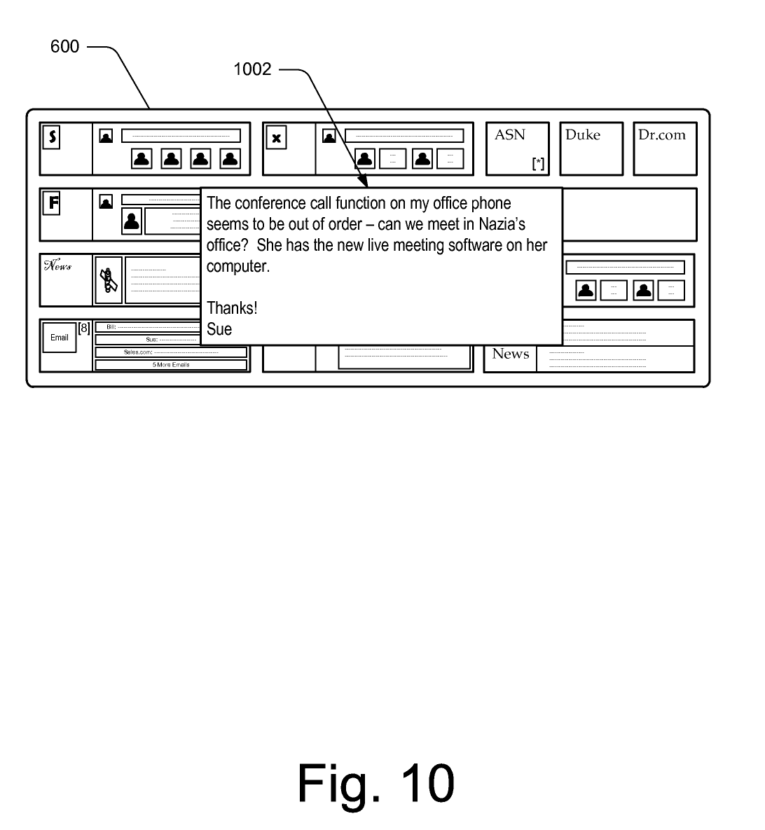

An example of this is shown in FIG. 10, which shows a pop-up window 1002 having more content associated with a reported change. This may also be used to expand the “5 More Emails” shown at section 812 in FIG. 8 to show, for example, the sender and subject lines for those emails. This may be used to show some content associated with a change for which no content is currently shown, such as change indicator 616 of FIG. 6. This alternative operation of block 506 permits a user to select to see more content associated with a change, which in some cases is enough for the user to forgo selecting the application generally.

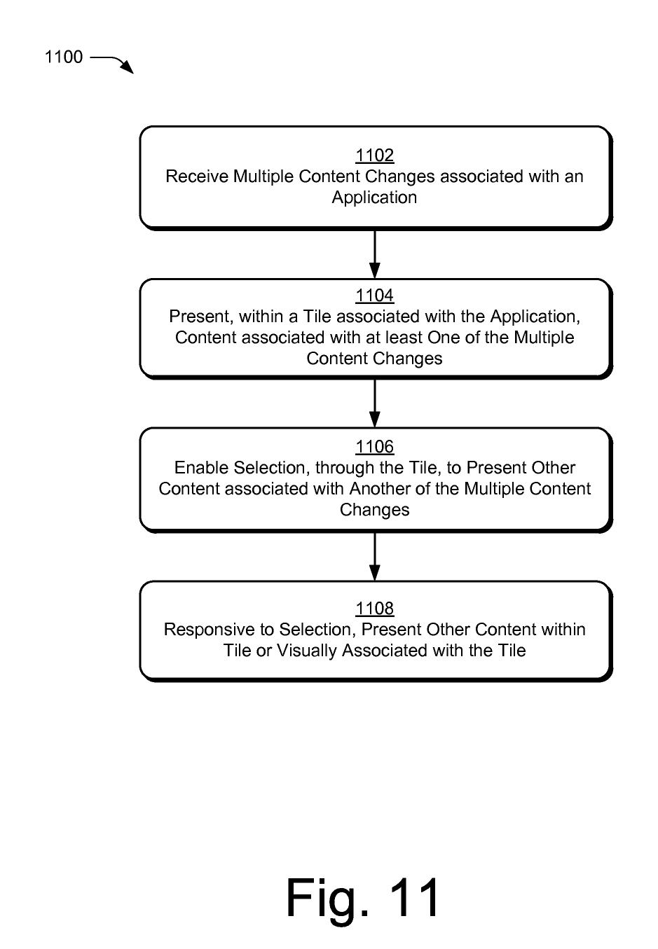

FIG. 11 depicts a method 1100 enabling presentation of, and browsing through, content changes of an application through a tile of a user interface. In portions of the following discussion reference may be made to environment 100 of FIG. 1 and as detailed in FIGS. 2-4, reference to which is made for example only.

Block 1102 receives multiple content changes associated with an application. These content changes can be new content for the application since a most-recent visit to the application, such as by a user of computing device 102, for example. This most-recent visit may be tracked and content determined to be new in manners set forth elsewhere herein, such as based on a prior launch or tracking by a remote entity providing content during active use of the application by a user. Content changes can be received in various manners set forth elsewhere herein, such as through one or more reports 110 of FIG. 1 received by reporter 210 of FIG. 2.

Block 1104 presents, within a tile associated with but not generated by an application, content associated with at least one of the multiple content changes received for the application. By way of example, consider again tile 602 of FIG. 6. Note that tile 602 in the context of method 1100 is part of a user interface but not necessarily a user interface having limitations and functions of user interface 600 of FIG. 6. For example, while user interface 600 includes multiple tiles, the tile of method 1100 may be part of, or substantially all of the visual presentation of, a user interface not having other tiles. Further, while tiles of user interface 600 described above are selectable to present an application associated with each tile, the tile of method 1100 may be selectable for other uses that may or may not include presenting the application.

Tile 602 illustrates presentation of three portions of content at 604, 606, and 608 in content presentation area 620 for one of multiple content changes, here an article about a weather satellite. The content presented in this case includes three portions of the content change for the application, though more or less of the content change may instead be presented. Assume that another content change has also been reported, such as another article that the user of computing device 102 has not yet viewed. In this example, content for this other content change has not yet been presented.

Block 1106 enables selection, through the tile, to present other content associated with another of the multiple content changes. The content in this example concerns articles for a news application, though any other types of content described herein may also or instead be presented, such as entries to a user's social networking application, emails for an email application, notifications for various types of applications, and others.

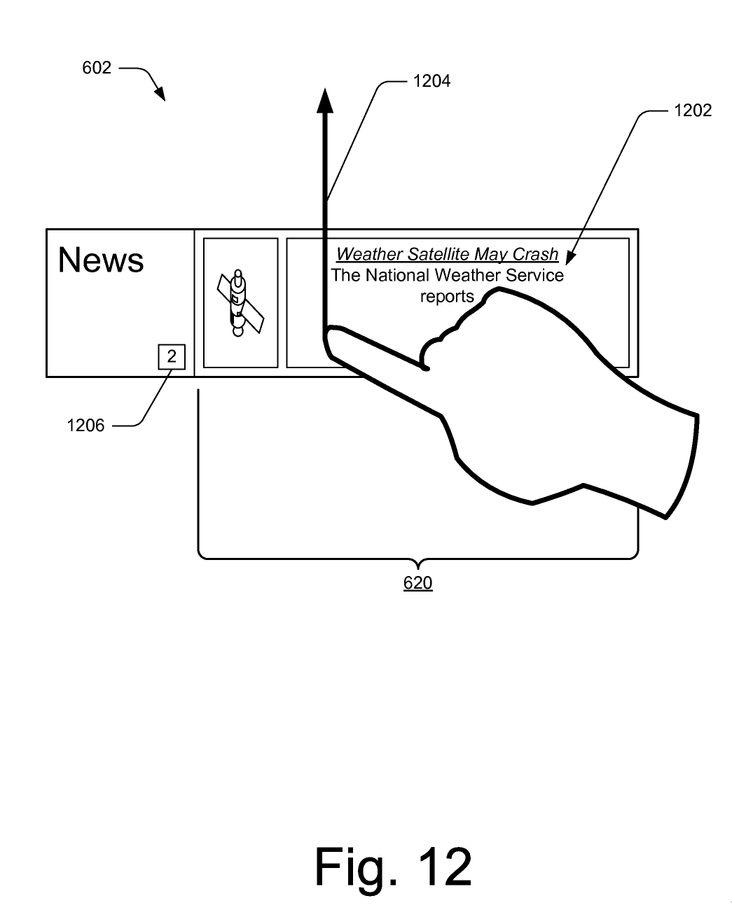

Continuing the ongoing example, consider FIG. 12, which illustrates tile 602. Here we assume that reporter 210 of FIG. 2 enables selection through the tile to present other content. This can be described as a “browsing” function. This selection can be enabled through various selection manners described in other examples herein, such as a gesture to a touch screen or movement or clicking of a mouse selector on content presentation area 620, to name a few.

For this example, selection to present content for another content change is received through a gesture 1202 starting within content presentation area 620 and moving upward, shown with arrow 1204. While not required, tile 602 also includes additional content change indicator 1206, which indicates that other content changes are also available for presentation, here two other articles. By way of further example, selection can be enabled also or instead through selection of indicator 1206, such as with a press gesture or a mouse click on indicator 1206.

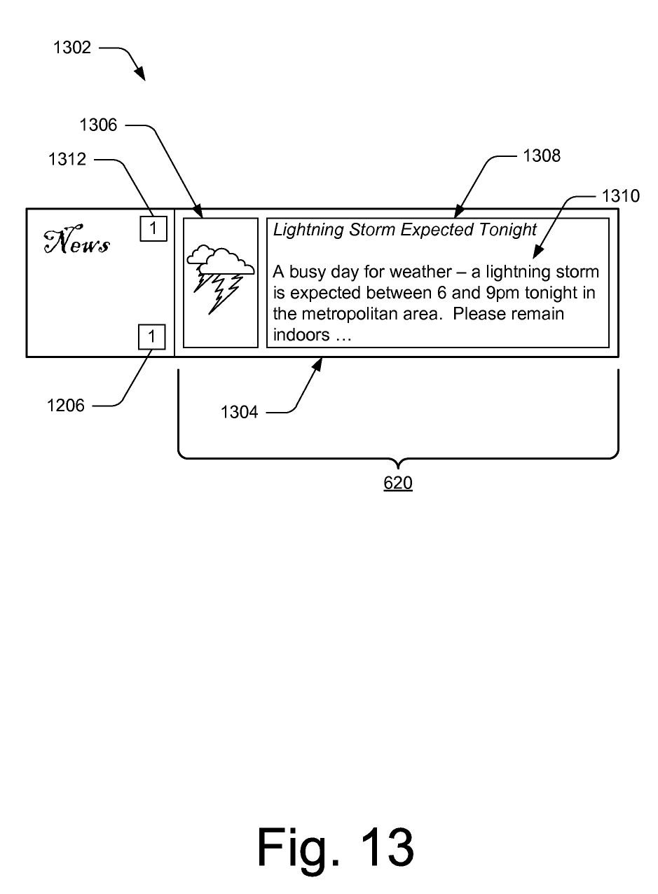

Block 1108 presents other content within the tile or visually associated with the tile responsive to the selection. Concluding the ongoing example, consider an updated version of tile 602 shown in FIG. 13 as updated tile 1302. Here content associated with another of the multiple content changes for the news application is shown generally at 1304 within the tile at content presentation area 620 and specifically with an image 1306, a title 1308, and a first portion of a body of the article at 1310. Note the change to indicator 1206 and addition of previous content indicator 1312. Indicator 1206 shows how many other content changes can be viewed (here one more article). Indicator 1312 indicates a number of content changes that have already been presented. Selection to return to the weather satellite article, for example, can be selected through a gesture opposite to that of gesture 1202 or by selecting indicator 1312, to name just a few.

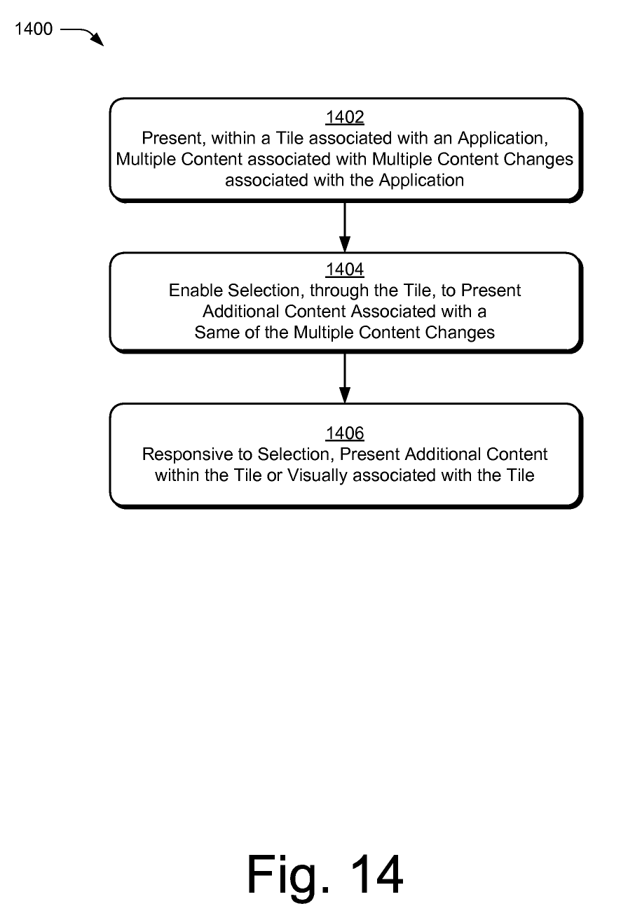

FIG. 14 depicts a method 1400 enabling presentation of multiple content changes associated with an application through a tile of a user interface. This and the other methods described herein may operate separately or in conjunction with each other. In portions of the following discussion reference may be made to environment 100 of FIG. 1 and as detailed in FIGS. 2-4, reference to which is made for example only.

Block 1402 presents, within a tile associated with an application, multiple content associated with multiple content changes of the application. Numerous examples of this are shown in user interface 600, such as tile 622 of FIGS. 6 and 8.

Consider again tile 622 as illustrated in FIG. 8, which shows application-identifying area 802 and content presentation area 804. Content presentation area 804 includes four selectable sections reporting changes, sections 806, 808, 810, and 812. Each of selectable sections 806, 808, and 810 reports content associated with a content change, here each a sender and a subject line of an email. Section 812 reports five changes, here that five other emails have also been received since the email application was last viewed by the user.

Block 1404 enables selection, through the tile, to present additional content. This additional content is associated with one of the multiple content changes that is already shown in part in the tile. Reporter 210, for example, can enable selection to expand the content coverage of one of the multiple content changes partially presented in the tile.

Block 1406 presents additional content associated with one of the same content changes already shown in the tile responsive to selection. Continuing the ongoing example, consider again FIG. 8, which illustrates selection by gesture 814. This selection, similar to as described in the context of method 500 above, is for presentation of additional content for a content change associated with the email application, here through section 808 to present more of the content associated with the email from Sue.

Reporter 210 may present this additional content within or visually associated with the tile. Content shown visually associated with a tile is illustrated at 1002 as part of user interface 600 of FIG. 10. This selection can be enabled in one or more of the numerous example selections described above, some of which displace other content of the tile or are superimposed over the tile and/or other tiles if included in the user interface.

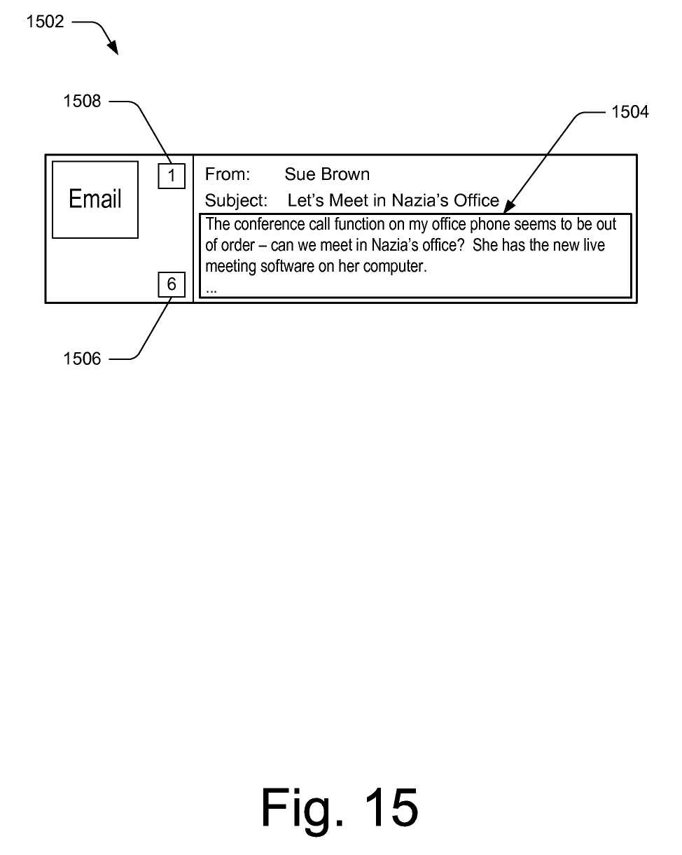

Additional content shown within a tile is illustrated at FIG. 15, which shows an altered version of tile 622 as altered tile 1502. Note that additional content 1504 is now presented, here some of the body of the email though not all of it is shown (the “Thanks, Sue” is missing but shown as missing with “ . . . ”). More or all of the content can further be selected through the tile or otherwise, such as with a gesture similar to that of FIG. 12 at gesture 1202 with direction shown at arrow 1204.

As shown in numerous example figures herein, a tile may be enlarged to better show details of the tile. This enlarging may be responsive to a user selection to enlarge a tile enabled by reporter 210, or responsive to another selection, such as to present different or additional content or on selection of a selectable indicator of a tile.

Note also that other content can be selected similarly as described in part in method 1100, namely through selection of indicators to move up or down through content changes. These indicators are shown in FIGS. 15 at 1506 and 1508.

In addition to these methods 500, 1100, and 1400, the techniques enable still other functions and methods, including those illustrated below.

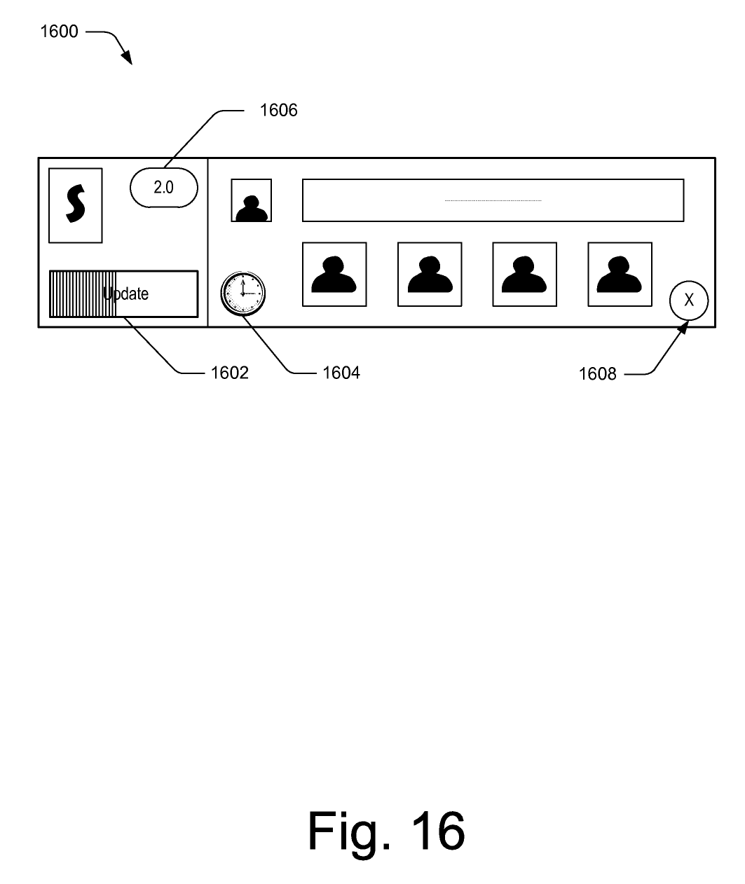

FIG. 16 illustrates an example tile 1600 as an aid in describing some of the many additional and/or alternative embodiments of the techniques. These additional and/or alternative embodiments may be used as part of, in additional to, or alternatively to those set forth above.

Tile 1600 includes indicators presenting various types of information about an associated application. Examples include an installation indicator 1602, an expiration indicator 1604, a software update indicator 1606, and an execution status indicator 1608. Installation indicator 1602 presents progress on installing the application associated with tile 1600 or progress on installing an update to the application (shown here). Expiration indicator 1604 presents an amount of time or number of uses before the application expires (e.g., a trial use or subscription expiring). Software update indicator 1606 indicates a current version of the application or that an update is available. Execution status indicator 1608 indicates whether or not the application is currently executing. Each of these indicators may include a graphic and/or text.

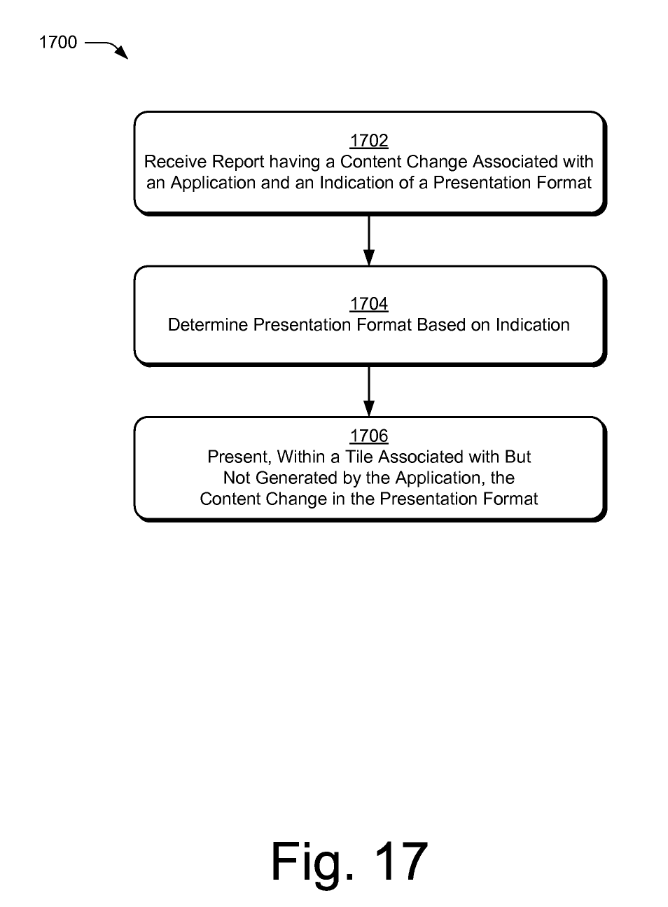

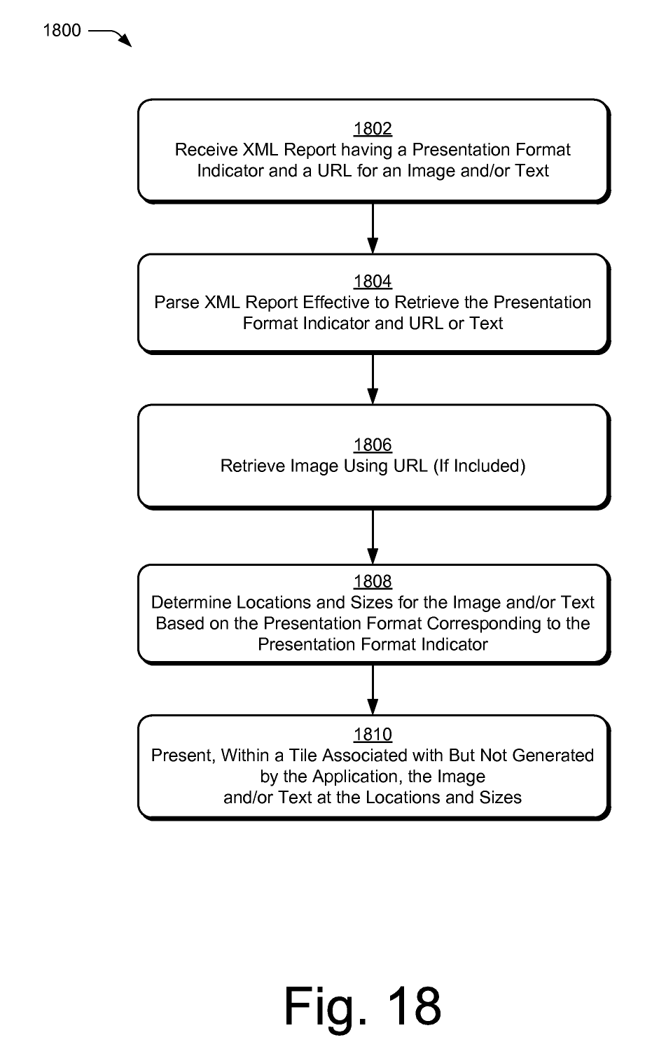

FIG. 17 depicts a method 1700 enabling presentation of a content change associated with an application according to a presentation format. Method 1700 is followed by method 1800 of FIG. 18, which also enables presentation of a content change according to a presentation format, but is described in the context of extensible markup language (XML). These methods, and the other methods described herein, may operate separately or in conjunction with each other in whole or in part. In portions of the following discussion reference may be made to environment 100 of FIG. 1 and as detailed in FIGS. 2-4, as well as methods and examples described above, reference to which is made for example only.

Block 1702 receives a report having a content change associated with an application along with an indication of a presentation format. This report can indicate a change with text and/or an image or image locator, and a presentation format in which to present the change. As noted in the description of reports 110 of above, reports 110 can be structured as a flat list, spreadsheet, XML document, or otherwise. Additionally, the reports can be received by any suitable data transport protocol such as really simple syndication (RSS), hypertext terminal protocol (HTTP), internet protocols, or any other transport protocol suitable for communicating content or metadata of a report.

Also as noted in part above, an entity associated with the application may select a presentation format, such as one of presentation formats 222 of FIG. 2, and indicate this in report 110 of FIG. 1. Thus, at some point prior to receiving report 110, the techniques may enable selection of multiple presentation formats 222, each having a layout and/or behavior. Content presented according to various presentation formats 222 is illustrated with the fourteen tiles of user interface 600 of FIG. 6. Tiles presenting content according to other presentation formats are illustrated in more detail with tile 602 of FIG. 6, tile 622 of FIG. 8, tile 1302 of FIG. 13, and tile 1502 of FIG. 15.

Block 1704 determines which presentation format in which to present the change based on the indication. Reporter 210 of FIG. 2, for example, can determine which of presentation formats 222 to present the change in interface 220 and, based on the determined presentation format 222, that an image and text should be presented at certain sizes and/or locations in a tile.

Block 1706 presents, within a tile associated with but not generated by the application and in the presentation format, content associated with the content change for the application. Presentation of content according to various example presentation formats 222 is illustrated in FIGS. 6, 8, 10, 12, 13, 15, and 16.

Before continuing with an example of the techniques in the context of XML, note that an entity associated with the application, such as report generator 306 of FIG. 3, can quickly and easily determine an appropriate presentation format 222 for presentation of content by reporter 210 on computing device 102. Further, report generator 306 does not necessarily have to perform complex or resource-intensive operations, such as image-density scaling, contrast adaptation, or re-flowing. Report generator 306 may also forgo having to determine, and adjust for, various differences between computing devices and their displays (e.g., laptop 102-1 and gaming device 102-6), a user's preferences, or a size of a tile in which the content is presented.

Further, note that reports 110 can be quite small, thereby reducing bandwidth resources and time to transmit reports over communication network 108. Reports 110, in some cases, include as little as a presentation format indicator and text or a URL.

Block 1802 receives an extensible markup language (XML) report having a presentation format indicator and a universal resource locator (URL) at which an image can be retrieved and/or text. The XML report can be received in the various manners described elsewhere herein, such as from report generator 306 of FIG. 3 or a local application associated with the tile.

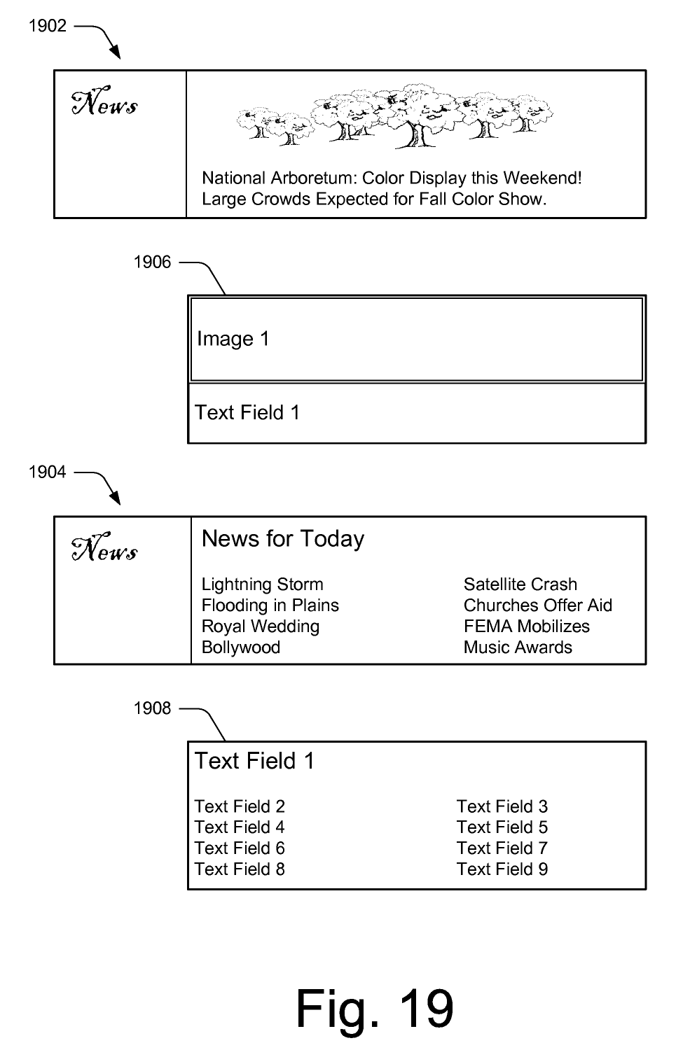

By way of example, consider FIG. 19, which illustrates two tiles 1902 and 1904 having content changes presented according to presentation formats 1906 and 1908, respectively. An entity deciding how to present content changes can select to use either of these presentation formats 1906 or 1908 (or many others, such as those of FIG. 6).

In a first example assume that report generator 306 selects presentation format 1906 to display an image and text. An XML report following presentation format 1906 can be represented as:

<?xml version=“1.0” encoding=“utf-8”?>

<tile>

<visual lang=“en-US”>

<binding template=“tile.wide.headline”>
<image id=“1” src=“image1.png”/>
<text id=“1”>Text field 1</text>

</binding>

</visual>

</tile>

Populated with a pseudo URL for an image and accompanying text, the XML report as presented in tile 1902 can be represented as:

<?xml version=“1.0” encoding=“utf-8”?>

<tile>

<visual lang=“en-US”>

<binding template=“tile.wide.headline”>

<image id=“1” src=“Trees.com”/>
<text id=“1”>National Arboretum: Color Display this
Weekend!

Large Crowds Expected for Fall Color Show.</text>

</binding>

</visual>

</tile>

By way of a second example, assume that report generator 306 selects presentation format 1908 to present various news headlines. Presentation format 1908 has a layout with a larger-font title for text field 1 and two columns of text: text fields 2, 4, 6, and 8 in a first column; and text for text fields 3, 5, 7, and 9 in a second column.

An XML report following presentation format 1908 can be represented as:

<?xml version=“1.0” encoding=“utf-8”?>

<tile>

<visual lang=“en-US”>

<binding template=“tile.wide.text.02”>
<text id=“1”>Text Field 1</text>
<text id=“1”>Text Field 2</text>
<text id=“1”>Text Field 3</text>
<text id=“1”>Text Field 4</text>
<text id=“1”>Text Field 5</text>
<text id=“1”>Text Field 6</text>
<text id=“1”>Text Field 7</text>
<text id=“1”>Text Field 8</text>
<text id=“1”>Text Field 9</text>

</binding>

</visual>

</tile>

Populated with text, the XML report as presented in tile 1904 can be represented as:

<?xml version=“1.0” encoding=“utf-8”?>

<tile>

<visual lang=“en-US”>

<binding template=“tile.wide.text.02”>
<text id=“1”>News for Today</text>
<text id=“1”>Lightning Storm</text>
<text id=“1”>Satellite Crash</text>
<text id=“1”>Flooding in Plains</text>
<text id=“1”>Churches Offer Aid</text>
<text id=“1”>Royal Wedding</text>
<text id=“1”>FEMA Mobilizes</text>
<text id=“1”>Bollywood</text>
<text id=“1”>Music Awards</text>

</binding>

</visual>

</tile>

Block 1804 parses the XML report effective to retrieve the presentation format indicator and the URL and/or the text. Continuing one of the above examples, reporter 210 parses the first-mentioned XML report to determine the URL for an image, one text field, and an indicator indicating presentation format 1906. With the presentation format indicator, block 1804 determines which presentation format 222 should be used.

Block 1806 retrieves the image using the URL in cases where the report includes a URL. While not required, including a URL rather than an image file can reduce bandwidth usage in some cases.

Block 1808 determines locations and sizes for the image and/or the text parsed from the XML report based on a presentation format corresponding to the presentation format indicator. Continuing the ongoing example, reporter 210 determines where to place the tree image and arboretum text presented in tile 1902. Note that reporter 210 may do so based on a current size of the tile (e.g., small or large as shown in FIG. 6) and perform image-density scaling, contrast adaptation, or re-flowing. Reporter 210 may also determine sizes and locations based on a user-selected preference, such as a color scheme or font size (e.g., for accessibility by visually impaired users). In some cases, the text or image is too large or small to fit in the determined size. In such cases reporter 210 may shrink, expand, or crop the image or text to fit the size.

Block 1810 presents, within a tile associated with an application but not generated by the application, the image and/or text at the locations and sizes. This is illustrated for the two example presentation formats 1906 and 1908 at tiles 1902 and 1904, respectively.

In some cases reporter 210 presents the image and/or text in HyperText Machine Language (HTML). In such cases, reporter 210 presents the image and/or text by transforming the XML report using an eXtensible Stylesheet Language Transformation (XSLT) associated with the presentation format.

The above two examples illustrates ways in which the techniques present content changes within a tile using an XML report. These two examples present a content change but in a static manner, absent some other operation. Some presentation formats 222, however, include behavior permitting animation, content change rotations, and other active operations.

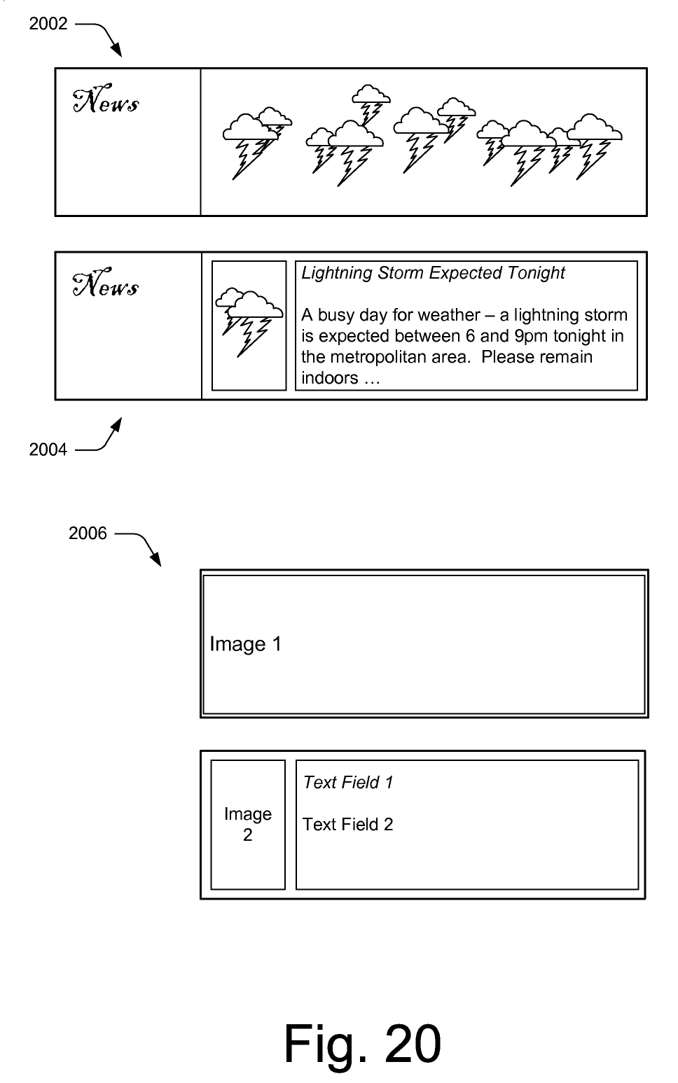

Consider, for example, FIG. 20, which illustrates a tile at two different times, a first presentation 2002 and a second presentation 2004. Note that both of these presentations 2002, 2004 can be presented based on a single report 110 (e.g., an XML report), which can based on one presentation format, namely presentation format 2006. An XML report following presentation format 2006 can be represented as:

<?xml version=“1.0” encoding=“utf-8”?>
<tile>

<visual lang=“en-US”>

<binding template=“tile.wide.picturestory.photo.05”>

<image id=“1” src=“image1.png”/>
<image id=“2” src=“image2.png”/>
<text id=“1”>Text Field 1</text>
<text id=“2”>Text Field 2</text>

</binding>

</visual>

</tile>

Populated with a pseudo URL for a large and small image and accompanying text, the XML report as presented in the tile can be represented as:

<?xml version=“1.0” encoding=“utf-8”?>
<tile>

<visual lang=“en-US”>

<binding template=“tile.wide.picturestory.photo.05”>

<image id=“1” src=“largelightningimage1.png”/>
<image id=“2” src=“smalllightningimage2.png”/>
<text id=“1”>Lightning Storm Expected Tonight</text>
<text id=“2”>A busy day for weather - a lightning storm is

expected between 6 and 9pm tonight in the metropolitan area. Please
remain indoors ...</text>

</binding>

</visual>

</tile>

Reporter 210 can switch from one presentation to another based on the presentation format, including animation during a transition from one presentation to another. In the context of the present example, reporter 210 can transition from presentation 2002 to presentation 2004 and vice versa. Reporter 210 may also rotate the two presentations, thereby permitting a user to see a larger image at one point and more text at another. In doing so, method 1800 may repeat various blocks.

The preceding discussion describes methods enabling a presentation format for an application tile as well as other methods. These methods are shown as sets of blocks that specify operations performed but are not necessarily limited to the order shown for performing the operations by the respective blocks.

Aspects of these methods may be implemented in hardware (e.g., fixed logic circuitry), firmware, a System-on-Chip (SoC), software, manual processing, or any combination thereof A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

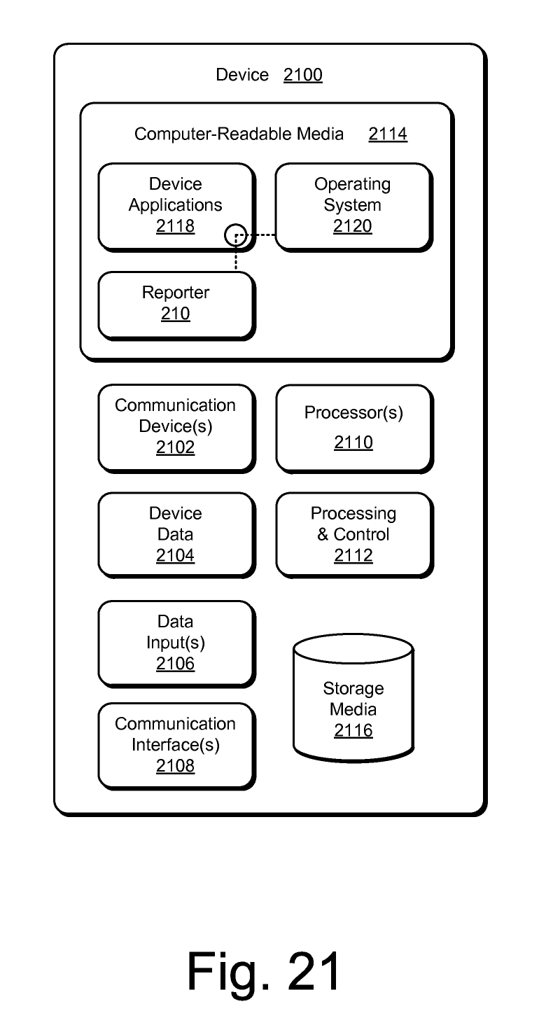

These techniques may be embodied on one or more of the entities shown in environment 100 of FIG. 1 (and as detailed in FIGS. 2-4) and/or example device 2100 described below, which may be further divided, combined, and so on. Thus, environment 100 and/or device 2100 illustrate some of many possible systems or apparatuses capable of employing the described techniques. The entities of environment 100 and/or device 2100 generally represent software, firmware, hardware, whole devices or networks, or a combination thereof In the case of a software implementation, for instance, the entities (e.g., reporter 210 of FIG. 2, report generator 306 of FIG. 3, and compiler module 406 of FIG. 4) represent program code that performs specified tasks when executed on a processor (e.g., processor(s) 202, 302, and 402, respectively). The program code can be stored in one or more computer-readable memory devices, such as computer-readable storage media 204, 304, or 404 or computer-readable media 2114 of FIG. 21. The features and techniques described herein are platform-independent, meaning that they may be implemented on a variety of commercial computing platforms having a variety of processors.

### Example Apparatus

FIG. 21 illustrates an apparatus having various components, here as part of, or containing, an example device 2100, which can be implemented as any type of client, server, and/or computing device as described with reference to the previous FIGS. 1-20 to implement techniques enabling a presentation format for an application tile. In embodiments, device 2100 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 2100 may also be associated with a user (e.g., a person) and/or an entity that operates the device such that a device describes logical devices that include users, software, firmware, and/or a combination of devices.

Device 2100 includes communication devices 2102 that enable wired and/or wireless communication of device data 2104 (e.g., received data, data that is being received, data scheduled for broadcast, data packets of the data, etc.). The device data 2104 or other device content can include configuration settings of the device, media content stored on the device, and/or information associated with a user of the device. Media content stored on device 2100 can include any type of audio, video, and/or image data. Device 2100 includes one or more data inputs 2106 via which any type of data, media content, and/or inputs can be received, such as user-selectable inputs, messages, music, television media content, recorded video content, and any other type of audio, video, and/or image data received from any content and/or data source.

Device 2100 also includes communication interfaces 2108, which can be implemented as any one or more of a serial and/or parallel interface, a wireless interface, any type of network interface, a modem, and as any other type of communication interface. The communication interfaces 2108 provide a connection and/or communication links between device 2100 and a communication network by which other electronic, computing, and communication devices communicate data with device 2100.

Device 2100 includes one or more processors 2110 (e.g., any of microprocessors, controllers, and the like), which process various computer-executable instructions to control the operation of device 2100 and to implement techniques enabling a presentation format for an application tile. Alternatively or in addition, device 2100 can be implemented with any one or combination of hardware, firmware, or fixed logic circuitry that is implemented in connection with processing and control circuits which are generally identified at 2112. Although not shown, device 2100 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 2100 also includes computer-readable storage media 2114, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 2100 can also include a mass storage media device 2116.

Computer-readable storage media 2114 provides data storage mechanisms to store the device data 2104, as well as various device applications 2118 and any other types of information and/or data related to operational aspects of device 2100. For example, an operating system 2120 can be maintained as a computer application with the computer-readable storage media 2114 and executed on processors 2110. The device applications 2118 may include a device manager, such as any form of a control application, software application, signal-processing and control module, code that is native to a particular device, a hardware abstraction layer for a particular device, and so on.

The device applications 2118 also include any system components or modules to implement techniques enabling a presentation format for an application tile. In this example, the device applications 2118 can include reporter 210 and applications 212.

### Conclusion

Although embodiments of techniques and apparatuses enabling a presentation format for an application tile have been described in language specific to features and/or methods, it is to be understood that the subject of the appended claims is not necessarily limited to the specific features or methods described. Rather, the specific features and methods are disclosed as example implementations enabling a presentation format for an application tile.

What is claimed is:

1. A computer-implemented method comprising:
receiving a report having a content change associated with an application along with an indication of a presentation format; and
presenting, within a tile associated with but not generated by the application and in the presentation format, content associated with the content change associated with the application.

2. A computer-implemented method as described in claim 1, further comprising, prior to receiving the report, enabling selection of multiple presentation formats, the multiple presentation formats each indicating a layout and a behavior of the tile.

3. A computer-implemented method as described in claim 2, further comprising determining the presentation format from the multiple presentation formats based on the indication.

4. A computer-implemented method as described in claim 1, wherein the report is a flat list including the indication, an image or image locator, and text.

5. A computer-implemented method as described in claim 1, wherein the report is received via a data transport protocol.

6. A computer-implemented method as described in claim 1, wherein the report includes the content associated with the content change, the content including text, an image, an image locator, or a user interface control element.

7. A computer-implemented method as described in claim 6, wherein presenting the content presents the text at a location within the tile indicated by the presentation format.

8. A computer-implemented method as described in claim 1, wherein the report includes a universal resource locator (URL) for the content and further comprising, prior to presenting the content, retrieving the content using the URL.

9. A computer-implemented method as described in claim 1, further comprising:
enabling selection, through the tile, to present other content associated with another content change to the application; and
responsive to selection, presenting the other content associated with the other content change to the application within the tile and according to the presentation format.

10. A computer-implemented method comprising:
receiving an extensible markup language (XML) report having:
a presentation format indicator, and
a universal resource locator (URL) at which an image can be retrieved, or
text;
parsing the XML report effective to retrieve the presentation format indicator and the URL or the text;
determining a location and a size for the image or the text based on a presentation format corresponding to the presentation format indicator; and
presenting, within a tile associated with an application but not generated by the application, the image or the text at the location and the size.

11. A computer-implemented method as described in claim 10, wherein the XML report includes the URL and further comprising retrieving the image using the URL.

12. A computer-implemented method as described in claim 11, wherein the XML report includes the text and the presenting presents the image and the text at different times.

13. A computer-implemented method as described in claim 11, further comprising, prior to presenting the image in the tile, shrinking or cropping the image based on the size.

14. A computer-implemented method as described in claim 11, wherein receiving the XML report is received from an entity associated with the application, the entity remote from a computing device on which the presenting is performed and retrieving the image retrieves the image from a source remote from the computing device.

15. A computer-implemented method as described in claim 10, further comprising determining a current tile size of two or more possible tile sizes associated with the application, and wherein determining the location and the size is based on the current tile size.

16. A computer-implemented method as described in claim 10, wherein the presenting transforms the XML report into hypertext machine language (HTML) using an extensible stylesheet language transformation (XSLT) associated with the presentation format.

17. A computer-implemented method as described in claim 10, wherein determining the location and the size is further based on a user-selected preference for a computing device on which the presenting is performed or the application.

18. A computer-implemented method as described in claim 10, wherein:
the XML report includes the URL and the text and further includes a second URL at which a second image can be retrieved and second text; and
parsing the XML report retrieves the second image and the second text.

19. A computer-implemented method as described in claim 18, wherein the presenting presents the first-mentioned image and the first-mentioned text at a different time than the second image and the second text.

20. A computer-implemented method as described in claim 19, further comprising animating a transition between presenting the first-mentioned image and text and the second image and the second text.
